(19) United States
(12) Patent Application Publication
(10) Pub. No.: US 2012/0113094 A1
(43) Pub. Date: May 10, 2012

(54) IMAGE PROCESSING APPARATUS, IMAGE PROCESSING METHOD, AND COMPUTER PROGRAM PRODUCT THEREOF

(76) Inventors: Kenichi Shimoyama, Tokyo (JP); Takeshi Mita, Kanagawa (JP); Nao Mishima, Tokyo (JP); Ryusuke Hirai, Tokyo (JP); Masahiro Baba, Kanagawa (JP); Io Nakayama, Kanagawa (JP)

(21) Appl. No.: 13/051,571

(22) Filed: Mar. 18, 2011

(30) Foreign Application Priority Data
Nov. 9, 2010 (JP) 2010-251267

(51) Int. Cl. G06T 15/00

(52) U.S. Cl. 345/419

(57) ABSTRACT

According to an embodiment, an image processing apparatus creates a depth map representing distribution of depths of pixels in an image. The apparatus includes an area detecting unit configured to detect an area of a vertical object included in an image; a base depth adding unit configured to add a base depth to the image, the base depth being a basic distribution of depths of pixels in the image; and, a depth map creating unit configured to acquire at least one depth of a vicinity of a ground contact position of the vertical object from the base depth added to the image, and create the depth map by setting the acquired depth onto the base depth as a depth of the area of the vertical object.

### CROSS-REFERENCE TO RELATED APPLICATIONS

This application is based upon and claims the benefit of priority from Japanese Patent Application No. 2010-251267, filed on Nov. 9, 2010; the entire contents of which are incorporated herein by reference.

### FIELD

Embodiments described herein relate generally to an image processing apparatus, an image processing method, and a computer program product.

### BACKGROUND

Conventionally, to display a two-dimensional image three-dimensionally, there are technologies of adding information about depth to the two-dimensional image. According to one of the conventional technologies, for example, from a distribution of high-frequency components in an upper part and a lower part of a two-dimensional image, a composition ratio to a depth model that is preliminarily prepared is calculated, and a rough depth of the whole of the image is obtained from a result of the calculation. Moreover, it is proposed that the depth is to be corrected by superimposing a red color signal (R signal) in a two-dimensional image onto a rough depth.

### BRIEF DESCRIPTION OF THE DRAWINGS

FIG. 1 is a schematic configuration diagram of an image processing apparatus according to a first embodiment;

FIG. 2 is a schematic diagram of an example of an input image according to the first embodiment;

FIG. 3 is a schematic diagram of an example of a base depth according to the first embodiment;

FIG. 4 is a schematic diagram of an example of a depth map that is created according to the first embodiment;

FIG. 5 is a flowchart of a flow in outline of an image processing method according to the first embodiment;

FIG. 6 is a schematic configuration diagram of an image processing apparatus according to a second embodiment;

FIG. 7 is a schematic diagram of an example of an input image on which a virtual line is set according to the second embodiment;

FIG. 8 is a schematic diagram of an example of a base depth that is created according to the second embodiment;

FIG. 9 is a schematic diagram of an example of a depth map that is created according to the second embodiment; and

FIG. 10 is a flowchart of a flow in outline of an image processing method according to the second embodiment.

### DETAILED DESCRIPTION

According to one embodiment, an image processing apparatus creates a depth map representing distribution of depths of pixels an image. The apparatus includes an area detecting unit configured to detect an area of a vertical object included in an image; a base depth adding unit configured to add a base depth to the image, the base depth being a basic distribution of depths of pixels in the image; and a depth map creating unit configured to acquire at least one depth of a vicinity of a ground contact position of the vertical object from the base depth added to the image, and create the depth map by setting the acquired depth onto the base depth as a depth of the area of the vertical object.

Various embodiments will be described hereinafter with reference to the accompanying drawings.

### First Embodiment

First of all, an image processing apparatus, an image processing method, and a computer program product thereof according to a first embodiment are explained below in detail with reference to the drawings. Explanations described below assume the following items (1) to (4). However, the present disclosure is not limited by these items.

(1) It is assumed that an upper left corner of the image is to be the origin, the traverse direction (horizontal direction) is an x axis, and the longitudinal direction (vertical direction) is a y axis. However, a coordinate system to be set on an image is not limited to this. A pixel value at coordinates (x, y) in the image is expressed as P(x, y). A pixel value P that indicates the brightness or a color component of a pixel is acceptable. For example, brightness, lightness, and specific color channel are applicable to such pixel value P.

(2) The depth map is data that represents depth of each pixel in an image. The depth map has the origin at the upper left corner of the map, the x axis in the traverse direction (horizontal direction), and the y axis in the longitudinal direction (vertical direction). However, a coordinate system to be set about the depth map is not limited to this. A pixel value at coordinates (X, Y) on the depth map is expressed as Z(X, Y). The pixel value Z is information indicating the depth of each pixel (depth information). For example, the larger the pixel value Z, the farther the depth of the pixel is.

(3) Coordinates on an image correspond to coordinates on a depth map one to one. According to the present disclosure, unless otherwise specifically described, the size of an image is equal to the size of a depth map. Moreover, coordinates (x, y) on an image and coordinates (X, Y) on a depth map correspond to each other. In other words, x=X, and y=Y are held.

(4) Unless otherwise specifically described in the present disclosure, the pixel value P on an image is to be described as “pixel value”, and a range of the value is [0, 255] (between 0 and 255). Furthermore, the pixel value Z on a depth map is to be described as “depth value”, and a range of the value is [0, 255] (between 0 and 253).

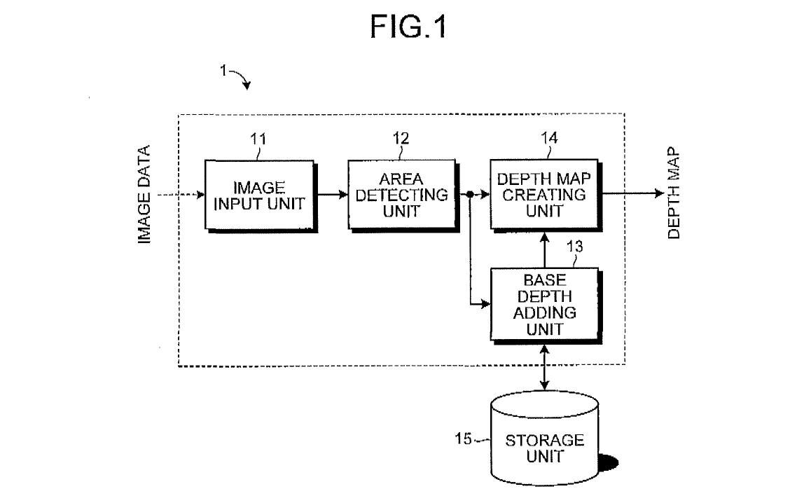

Next, an image processing apparatus 1 according to the first embodiment is explained below in detail with reference to the drawings. FIG. 1 is a schematic configuration diagram of the image processing apparatus 1 according to the first embodiment. As shown in FIG. 1, the image processing apparatus 1 includes an image input unit 11, an area detecting unit 12, a base depth adding unit 13, and a depth map creating unit 14.

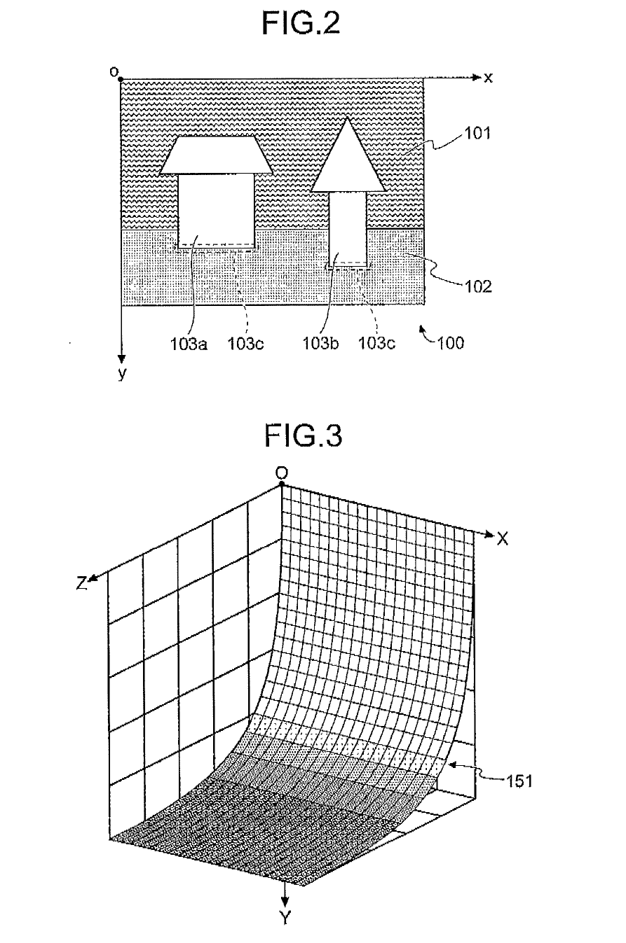

The image input unit 11 receives a two-dimensional image to be processed (hereinafter, “input image”). The input image can be either a still image or a moving image. FIG. 2 depicts an example of an input image. As shown in FIG. 2, an input image 100 includes a sky area 101 showing the sky and a ground area 102 showing the ground, as broadly divided. The input image 100 includes vertical object areas 103a and 103b that are areas showing vertical objects. The ground area 102 is a plane area to be a base on the underside of the space of the input image 100, for example, a horizontal plane, such as a ground or a water surface, or a nearly horizontal plane, such as a slope. The ground area 102 can include a horizontal plane in a vertical object, such as a rooftop of a building. The sky area 101 is an area of a part different from the ground area, for example, the sky, a fence, or a ceiling. A vertical object includes the whole of an object that is present at an angle vertical or nearly vertical to the ground area 102, or a vertical plane of the object. A vertical object area is an area showing a vertical object on the input image 100. According to the example shown in FIG. 2, the vertical object area 103a is an area showing a house, and the vertical object area 103b is an area showing a tree. Unless otherwise particularly distinguished between the vertical object areas 103a and 103b, each of them is denoted by a reference numeral 103 in the following explanations.

Returning to FIG. 1, the explanation is continued below. Any device or any medium can be applied to an input source of the input image 100. For example, the image input unit 11 preferably receives input of image data from a recording medium, such as a Hard Disk Drive (HDD), a Digital Versatile Disk Read-Only Memory (DVD-ROM), or a flash memory. The image input unit 11 preferably receives input of image data from an external device connected via a network, such as a video recorder, a digital camera, or a digital video camera. Furthermore, the image input unit 11 can be a receiver that receives television broadcasting via wireless or wired communication.

Furthermore, the format of the input image is not necessarily a two-dimensional image. For example, it can be a stereoscopic image, such as a side-by-side format or a line-by-line format, or an image in multiple-viewpoint format. In such case, an image of one of the viewpoints is treated as an image to be processed.

The area detecting unit 12 detects the vertical object area 103 included in the input image 100. A generally known method can be used for detection of the vertical object area 103. Among existing detection methods, there is a method of classifying the vertical object area 103 from the input image 100, for example, by using a classifier for vertical object detection. However, not limited to this, various detection methods are applicable. The area detecting unit 12 can detect a segmented vertical object area segmented from the vertical object area 103. For example, a method of segmenting the vertical object area 103 into units of object is conceivable.

The base depth adding unit 13 adds a base depth to the input image 100. The base depth is, for example, data of a three-dimensional spatial structure having depth. Depth information included in the base depth is expressed by numeric value (pixel value or depth value), for example. Such base depth can be used as basic data of depth when creating a depth map about the input image 100.

An example of a base depth is shown in FIG. 3. As shown in FIG. 3, a base depth 151 is composed of one or more combinations of planes or curved surfaces formed in a three-dimensional space given by an x axis, a y axis, and a z axis. The base depth 151 shown in FIG. 3 is in a curved form such that the closer to the upper limit (255) of the y coordinate the area is, the closer to the front the area is positioned, and the closer to the origin O of the y coordinate the area is, the farther position the area is positioned at. The base depth 151 in such form is suitable for an image that the ground is extending in the lower part of the image, and the sky, a building, and the like are in the upper part.

Returning to FIG. 1, the explanation is continued below. The base depth 151 can be preliminarily prepared, for example, in a storage unit 15. The storage unit 15 can preliminarily store therein a plurality of base depths as templates. The base depth adding unit 13 specifies a template of a base depth appropriate to the input image 100, for example, by analyzing the input image 100, and acquires the template from the storage unit 15. Specification of a base depth appropriate to the input image 100 can be performed, for example, based on a spatial structure that is specified or estimated from the input image 100. According to the specification method, the spatial structure of the input image 100 is specified or estimated, for example, from an area of the ground or a floor (the ground area 102 according to the present example), or an area of the sky or a ceiling (the sky area 101 according to the present example) on the input image 100. The base depth 151 appropriate to the spatial structure is then specified from the storage unit 15. However, not limited to this specification method, a base depth can be obtained by using various methods. Furthermore, the base depth adding unit 13 can use a base depth estimated from the input image 100, instead of the base depth 151 that is preliminarily prepared.

The depth map creating unit 14 calculates information about depth of a vicinity of ground contact position 103c of each of the vertical object areas 103 detected from the input image 100, from the base depth 151 added to the input image 100. The vicinity of ground contact position 103c here can be, for example, the bottom or the bottommost edge of each of the vertical object areas 103, or an area of a few pixels (for example, three pixels) around the edge. However, it is not limited to these. It can be variously modified in shape, for example, the vicinity of ground contact position 103c can be an area which includes the bottom or the bottommost edge of each of the vertical object areas 103 and in which the size of the area relative to the image in the traverse direction and the size of that in the longitudinal direction are both 5% or less than the size of the input image 100. In the following explanations, information about depth that is calculated for the vicinity of ground contact position 103c of each of the vertical object areas 103 is referred to as, for example, a vertical object depth value. Here, as described above, by associating coordinates (x, y) of a pixel in the input image 100 with coordinates (X, Y) of a pixel in the base depth 151, a depth value Z(X, Y) of a pixel included in the vicinity of ground contact position 103c can be easily specified. As a result, a vertical object depth value of each of the vicinities of ground contact positions 103c can be easily calculated from the specified depth value Z(X, Y). An example of a calculation method of a vertical object depth value will be mentioned later.

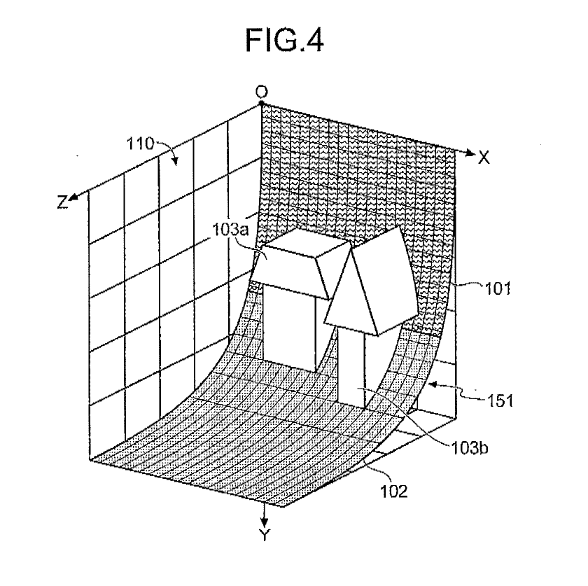

The depth map creating unit 14 sets the information about depth of each of the vertical object areas 103 onto the depth map by using the calculated vertical object depth value. The information about depth of the vertical object area 103 can be easily created, for example, from the vertical object depth value. For example, the depth map creating unit 14 can set directly a vertical object depth value calculated for each of the vicinities of ground contact positions 103c onto the depth map as the information about depth (the depth value Z) of each of the vertical object areas 103. FIG. 4 depicts an example of a depth map that is created according to the first embodiment.

As shown in FIG. 4, a depth map 110 has a structure that the information about depth (the depth value Z) of each of the sky area 101 and the ground area 102 is set to the depth value Z of the base depth 151. On the depth map 110, the information about depth (the depth value Z) of each of the vertical object areas 103a and 103b is set to a vertical object depth value that is specified from the base depth 151 based on each of the vicinities of ground contact positions 103c.

Various methods can be applicable to the calculation method of a vertical object depth value. Some of them are described below. However, it is not limited to the following examples.

(1) A method of setting a vertical object depth value to the depth value Z of a pixel in the base depth 151 corresponding to a pixel in the vertical object area 103

(2) A method of setting a vertical object depth value to an average of the depth values Z of pixels in the base depth 151 corresponding to pixels in the vertical object area 103

(3) A method of setting a vertical object depth value to the maximum value of the depth values Z of pixels in the base depth 151 corresponding to pixels in the vertical object area 103

(4) A method of setting a vertical object depth value to the minimum value of the depth values Z of pixels in the base depth 151 corresponding to pixels in the vertical object area 103

(5) A method of setting a vertical object depth value to the median of a range between the minimum value and the maximum value of the depth values Z of pixels in the base depth 151 corresponding to pixels in the vertical object area 103

Various methods can be applied to the setting method of setting a vertical object depth value onto the depth map 110 as the depth value Z of the vertical object area 103. Some of them are described below. However, it is not limited by the following examples.

(1) A method of setting a vertical object depth value as the depth value Z per longitudinal line of pixels in the vertical object area 103

(2) A method of setting a vertical object depth value as the depth value Z of each of the vertical object areas 103

(3) A method of setting a vertical object depth value as the depth value Z of all of the vertical object areas 103 in the input image 100

According to the setting method described in (3) as an example, it is adequate to obtain a vertical object depth value with respect to the vicinity of ground contact position 103c of any one of the vertical object areas 103 in the input image 100. However, not limited to this, the average, the maximum value, the minimum value, or the median of respective vertical object depth values calculated for the vicinities of ground contact positions 103c of a plurality of or all of the vertical object areas 103 can be set as the depth value Z of all of the vertical object areas 103. When the area detecting unit 12 detects a segmented vertical object area segmented from the vertical object area 103, the depth map creating unit 14 can give a depth to each of the segmented area.

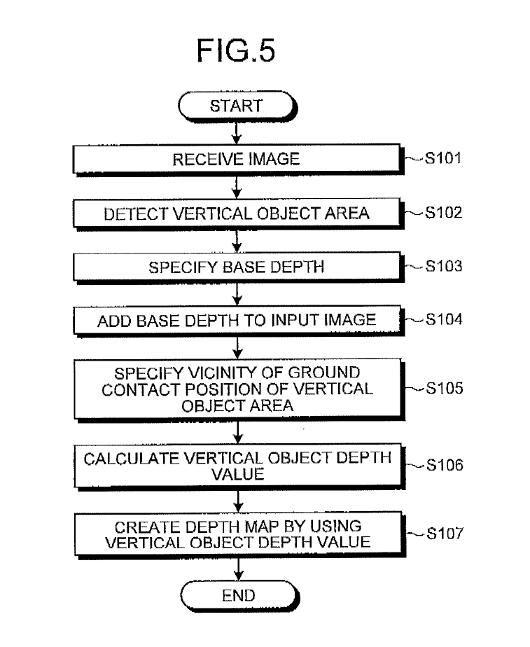

A flow of an image processing method executed by the image processing apparatus 1 according to the first embodiment is then explained below in detail with reference to the drawings. FIG. 5 is a flowchart of a flow in outline of an image processing method according to the first embodiment.

As shown in FIG. 5, according to the operation, to begin with, the image input unit 11 receives input of the input image 100 (Step S101). The image input unit 11 inputs the input image 100 into the area detecting unit 12. The area detecting unit 12 detects the vertical object area 103 included in the input image 100 by analyzing the input image 100 (Step S102). The detected vertical object area 103 is input into the depth map creating unit 14. The area detecting unit 12 inputs the input image 100 into the base depth adding unit 13.

When it is configured such that the base depth adding unit 13 specifies the base depth 151 to be added based on the sky area 101 and the ground area 102 in the input image 100, the area detecting unit 12 can detect the sky area 101 and the ground area 102 in the input image 100 at Step S102. The sky area 101 and the ground area 102 that are detected are input into the base depth adding unit 13, for example, together with the input image 100. However, not limited to this, it can be configured to add the base depth 151 that is predetermined for the input image 100.

The base depth adding unit 13 then specifies the base depth 151 to be added to the input image 100 from the storage unit 15 (Step S103). When specifying, the base depth adding unit 13 can specify the base depth 151 to be added based on the sky area 101 and the ground area 102 that are detected from the input image 100. Subsequently, the base depth adding unit 13 adds the specified base depth 151 to the input image 100 (Step S104). The input image 100 given with the base depth 151 is input into the depth map creating unit 14.

The depth map creating unit 14 specifies at first the vicinity of ground contact position 103c of each vertical object area 103, from the vertical object area 103 input from the area detecting unit 12 and the input image 100 with the base depth 151 input from the base depth adding unit 13 (Step S105); and then calculates a vertical object depth value of the vicinity of ground contact position 103c according to the above calculation method (Step S106). The depth map creating unit 14 then sets the calculated vertical object depth value onto the base depth 151 as the information about depth (the depth value Z) of the vertical object area 103, thereby creating the depth map 110 (Step S107); and then terminates the processing. Accordingly, the depth map 110 as shown in FIG. 4 is created. A setting method of setting a vertical object depth value onto the depth map 110 as the depth value Z of the vertical object area 103 can be the method that is described above or others.

By configuring and operating in this way as described above, according to the first embodiment, because the depth of a vertical object is set based on the position of the vertical object on the base depth, a depth that is more precise to the vertical object can be set. As a result, a structure (depth map) with more accurate depth can be created from a two-dimensional image.

For example, when correcting a base depth by using a red color signal (R signal) in an image, the head of a person has generally a small R signal, and the skin has a large R signal. For this reason, on a depth map that is obtained through correction using R signals, the depth of the head of a person and the depth of the face that are supposed to be close to each other are sometimes different from each other to a large extent in some cases. In other words, sometimes there is a problem such that the head is positioned on the back side, and the face is positioned in the front side. In contrast, according to the first embodiment, assuming that the whole of a person is a vertical object, a depth on the base depth can be calculated from a ground contact position of the vertical object, and can be set as the depth of the person, therefore, a more precise depth structure can be obtained.

### Second Embodiment

Then, an image processing apparatus, an image processing method, and a computer program product thereof according to a second embodiment of the present invention are explained below in detail with reference to the drawings. In the following explanations, configurations similar to the first embodiment are assigned with the same reference numerals, and repeated explanations of them are omitted.

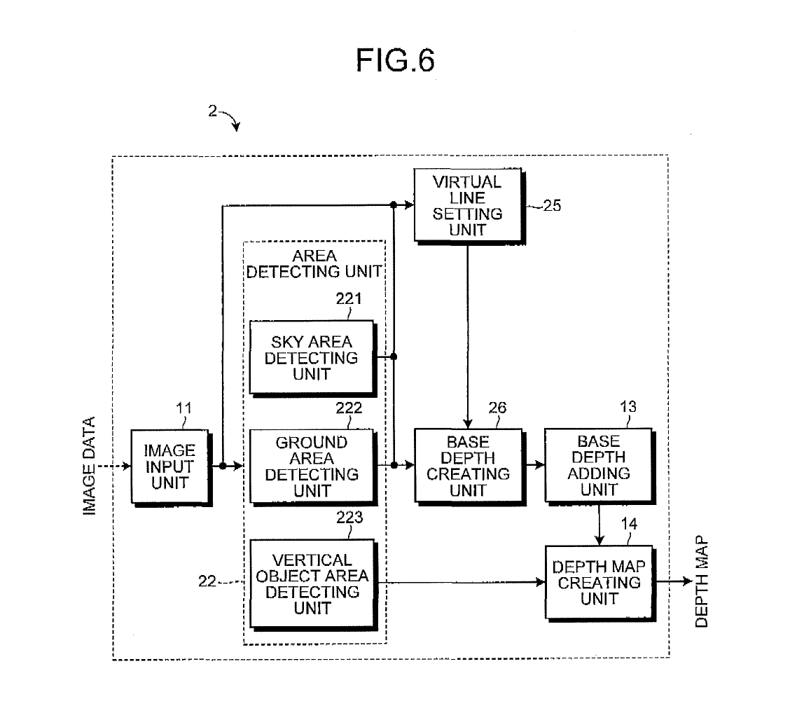

FIG. 6 is a schematic configuration diagram of an image processing apparatus 2 according to the second embodiment. As it is obvious by comparing FIG. 6 and FIG. 1, the image processing apparatus 2 (FIG. 6) includes a configuration similar to that of the image processing apparatus 1 (FIG. 1). However, the area detecting unit 12 in the image processing apparatus 1 is replaced with an area detecting unit 22 in the image processing apparatus 2. Moreover, the image processing apparatus 2 further includes a virtual line setting unit 25 and a base depth creating unit 26.

The area detecting unit 22 includes a vertical object area detecting unit 223 that detects the vertical object area 103 from the input image 100, a ground area detecting unit 222 that detects the ground area 102, and a sky area detecting unit 221 that detects the sky area 101. The vertical object area detecting unit 223 is equivalent to, for example, the area detecting unit 12 according to the first embodiment. As described above, the area detecting unit 12 according to the first embodiment can detect the sky area 101 and the ground area 102, similarly to the area detecting unit 22 according to the second embodiment. To detect each area of a vertical object, the sky, and the ground, a generally known method can be used. Among known detection methods, for example, there is a method by using a classifier with respect to each area. Moreover, another method by performing detection of two kinds of areas among three kinds of areas that are vertical object, sky, and ground, and determining the rest of the area as an area of the left kind is conceivable. In such case, when categorizing areas into four or more kinds, one kind 18 to be left and the other kinds are to be detected.

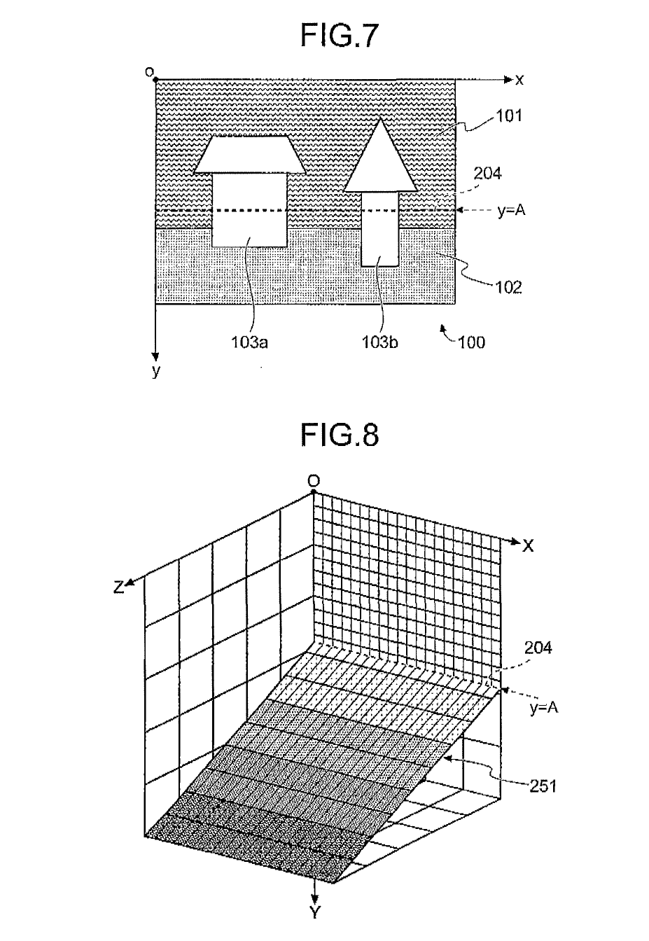

The virtual line setting unit 25 sets a virtual line for obtaining a base depth. Specifically, the virtual line setting unit 25 sets a virtual line that is a line virtually lying between the ground and the sky to be used when obtaining a base depth. FIG. 7 depicts an example of an input image on which a virtual line is set. As shown in FIG. 7, a virtual line 204 can be a line of setting the farthest position of the ground, and does not need to be the horizon in the strict sense. For example, according to the example shown in FIG. 7, the virtual line 204 does not match the line between the sky area 101 and the ground area 102. However, a depth of the virtual line 204 is acceptable on condition that the depth is farther than the lower area under the virtual line 204 in the input image 100. This includes that the depth of the virtual line 204 is equivalent to the depth of the sky area 101.

Various methods can be applicable to the setting method of setting the virtual line 204 configured in this way. Some of them are described below. However, it is not limited to the following examples.

(1) A method of setting the virtual line 204 at a horizontal line passing through the center of the input image 100 (y=y_max/2, where y_max denotes the maximum value of the y coordinate of the input image 100)

(2) A method of setting the virtual line 204 to the upper end (y=0) of the input image 100

(3) A method of setting the virtual line 204 at the horizon by detecting the horizon from the input image 100

(4) A method of setting the virtual line 204 at a horizontal line passing through a vanishing point obtained by detecting a vanishing line from the input image 100

(5) A method of setting the virtual line 204 at a horizontal line passing through the uppermost end of the ground area 102 detected from the input image 100

(6) A method of setting the virtual line 204 at the upper end line of the ground area 102 detected from the input image 100

(7) A method of setting the virtual line 204 at a horizontal line passing through the center of gravities of the ground area 102 and the sky area 101 detected from the input image 100

Returning to FIG. 6, the explanation is continued below. The base depth creating unit 26 creates a base depth to be added to the input image 100 by using the virtual line 204 thus set. An example of a method of creating a base depth by using the virtual line 204 is explained below. The following explanation describes a case where the virtual line 204 expressed by a line y=A is set, as an example.

In the example, Zb denotes the depth value of the virtual line 204, and Zd denotes the depth value of the lower end (y=y_max) of the input image 100 (Zb≧Zd). The depth value Zb of the virtual line 204 can be the maximum value (for example, 255) of the range of the depth value Z, or can be a value that is calculated from at least one of spatial spreads, the sky area 101 and the ground area 102, which are detected from the input image 100. The depth of a lower area under the virtual line 204 is calculated, for example, based on a position at which the virtual line 204 is set. When calculated, it is preferable that the lower the in the area, the smaller depth value Z the lower area under the virtual line 204 has, while the closer to the virtual line 204, the larger depth value Z the lower area has. The depth value Z (X, Y) of a pixel (x, y) in a lower area (y>A) under the virtual line 204 can be expressed by Expression (1) described below. According to Expression (1), the lower area under the virtual line 204 has a depth structure in which the depth value Z linearly increases with approaching the virtual line 204 from the lower end of the input image 100. However, not limited to this, it can be modified in any form on condition that the depth increases with approaching the virtual line 204 from the lower end of the input image 100.

$$Z ( X , Y ) = Zd + ( Zb - Zd ) \times \frac{( y - A )}{( y max - A )} \qquad ( 1 )$$

where, Y>A

The upper area on and above the virtual line 204 can be set at the depth value Zb at the farthest position, as expressed below in Expression (2). However, the farthest position meant above is not limited to the maximum value of the range of the depth value Z (for example, 255), and can be any value on condition that it is the maximum among the depth values Z in the depth map of the input image 100. The virtual line 204 can be set in front of the upper area above the virtual line 204. In such case, the upper area above the virtual line 204 is the farthest area.

Z(X,Y)=Zb (2)

where, Y≦A

An area between the lower end of the input image 100 and the virtual line 204 (Y>A) can be variously modified in form, for example, to a function by which the depth value Z inversely decreases with increasing Y, as expressed below in Expression (3).

$$Z ( X , Y ) = Zd \frac{( Zb - Zd )}{( Y - A )} \qquad ( 3 )$$

where, Y>A

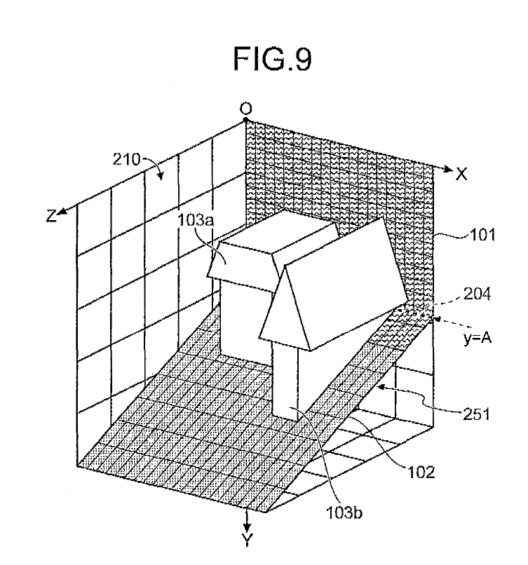

An example of a base depth created by the creating method by using Expression (1) and Expression (2) described above is shown in FIG. 8. As shown in FIG. 8, according to the base depth 151, in the lower area under the virtual line 204, the larger the y coordinate is, the closer to the front the position is, and the closer to the virtual line 204 the position is, the farther the position is. The upper area on and above the virtual line 204 is at the farthest position. A base depth 251 that is created as described above is input into the base depth adding unit 13. The base depth adding unit 13 adds the base depth 251 to the input image 100, similarly to the first embodiment. The depth map creating unit 14 calculates a vertical object depth value by using the base depth 251 similarly to the first embodiment, and sets information about depth of the vertical object area 103 onto a depth map, by using the vertical object depth value. FIG. 9 depicts an example of a depth map that is created according to the second embodiment.

As shown in FIG. 9, a depth map 210 has a structure in which each of the information about depth (the depth value Z) of the sky area 101 and the ground area 102 is set to the depth value Z of the base depth 251. On the depth map 210, the information about depth (the depth value Z) of each of the vertical object areas 103a and 103b is set to a vertical object depth value specified from the base depth 251 based on each of the vicinities of ground contact positions 103c.

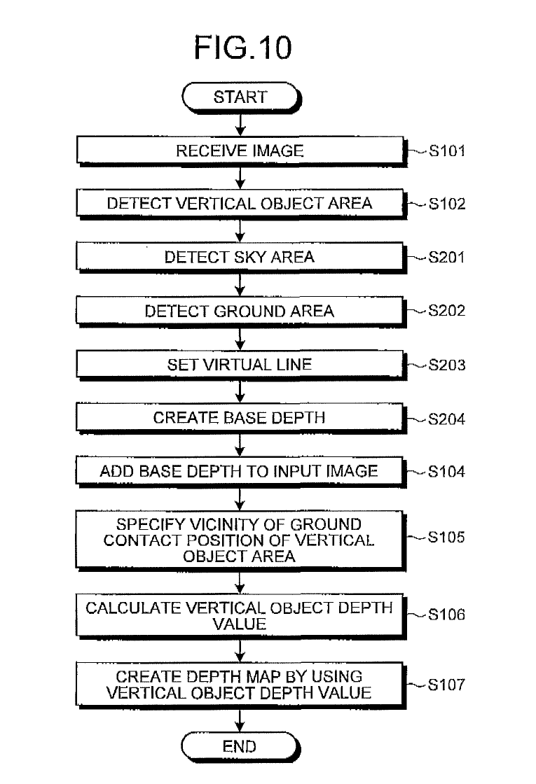

Subsequently, a flow of an image processing method to be executed by the image processing apparatus 2 according to the second embodiment is explained below in detail with reference to the drawings. FIG. 10 is a flowchart of a flow in outline of an image processing method according to the second embodiment.

As shown in FIG. 10, according to the operation, through processes similar to Steps S101 and S102 shown in FIG. 5, the vertical object area detecting unit 223 of the area detecting unit 22 detects the vertical object area 103 included in the input image 100. The input image 100 input at Step S101 is also input into the virtual line setting unit 25, in addition to the area detecting unit 22.

Based on a depth created according to the first embodiment, by obtaining a shift amount of each pixel in the input image 100, and shifting the input image 100, an image that is observed from another view point different from the input image 100 can be created. Therefore, multiple viewpoint images that are observed from two or more view points are created from the input image 100, and displayed on a display device for stereoscopic image display, thereby enabling stereoscopic vision. An image that is observed from another view point different from the input image 100 can be created, for example, by rendering based on another view point.

In the second embodiment, the sky area detecting unit 221 of the area detecting unit 22 then detects the sky area 101 included in the input image 100 (Step S201); and furthermore, the ground area detecting unit 222 detects the ground area 102 included in the input image 100 (Step S202). The detected vertical object area 103 is input into the depth map creating unit 14. The detected sky area 101 and the detected ground area 102 are each input into the virtual line setting unit 25 and the base depth creating unit 26.

The virtual line setting unit 25 calculates the virtual line 204 to be set onto the input image 100 from the input image 100 that is input from the image input unit 11, and the sky area 101 and the ground area 102 that are input from the area detecting unit 22, and sets the virtual line 204 onto the input image 100 (Step S203). The calculation method of the virtual line 204 is as described above. The input image 100 on which the virtual line 204 is set is input into the base depth creating unit 26.

The base depth creating unit 26 creates the base depth 251 based on the virtual line 204 set on the input image 100 (Step S204). The creating method of the base depth 251 is as described above. The created base depth 251 is input into the base depth adding unit 13 together with the input image 100.

Similarly to Step S104 shown in FIG. 5, the base depth adding unit 13 adds the base depth 251 into the input image 100 (Step S104); subsequently through processes similar to Steps S105 to S107 in FIG. 5, the base depth adding unit 13 creates the depth map 110. Accordingly, the depth map 210 as shown in FIG. 9 is created.

By configuring and operating in this way as described above, according to the second embodiment, because the virtual line 204 is set onto the input image 100, and the base depth 251 to be added to the input image 100 is created based on the virtual line 204; the base depth 251 that is closer to an actual depth structure in the input image 100 can be created and used. As a result, a structure (depth map) with more accurate depth can be created from a two-dimensional image. The other configurations, operations, and effects are similar to those according to the first embodiment, therefore detailed explanations are omitted here.

The image processing apparatus and the image processing method according to the above embodiments can be implemented by either software or hardware. When implementing by software, the image processing apparatus and the image processing method are implemented by reading a predetermined computer program with an information processor, such as a Central Processing Unit (CPU), and executing it. The predetermined computer program can be recorded in a recording medium, for example, a Compact Disk Read Only Memory (CD-ROM), a Digital Versatile Disk Read Only Memory (DVD-ROM), or a flash memory, or can be recorded in a storage device connected to a network. The information processor reads or downloads the predetermined computer program, and then executes it.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus that creates a depth map representing distribution of depths of pixels in an image, the apparatus comprising:
an area detecting unit configured to detect an area of a vertical object included in an image;
a base depth adding unit configured to add a base depth to the image, the base depth being a basic distribution of depths of pixels in the image; and
a depth map creating unit configured to acquire at least one depth of a vicinity of a ground contact position of the vertical object from the base depth added to the image, and create the depth map by setting the acquired depth onto the base depth as a depth of the area of the vertical object.

2. The apparatus according to claim 1, further comprising:
a setting unit configured to set a virtual line on the image; and
a base depth creating unit configured to create the base depth based on the image onto which the virtual line is set, wherein
the base depth represents distribution in which the virtual line is set at a farthest position of the image.

3. The apparatus according to claim 2, wherein the setting unit sets the virtual line in a vicinity of a horizon included in the image.

4. The apparatus according to claim 2, wherein the setting unit sets the virtual line so as to pass through a vanishing point in the image.

5. The apparatus according to claim 2, wherein
the area detecting unit includes a ground area detecting unit that detects a ground area included in the image, and
the setting unit sets the virtual line in accordance with a distribution of the ground area.

6. The apparatus according to claim 2, wherein
the area detecting unit includes
a ground area detecting unit that detects a ground area included in the image, and
a sky area detecting unit that detects a sky area included in the image, and
the setting unit sets the virtual line in accordance with the ground area and the sky area.

7. The apparatus according to claim 5, wherein the depth map creating unit calculates a depth of the ground area based on a position of the virtual line set on the image.

8. The apparatus according to claim 6, wherein the depth map creating unit calculates a depth of the ground area based on a position of the virtual line set on the image.

9. The apparatus according to claim 6, wherein the depth map creating unit sets a depth of the virtual line to a depth of the sky area.

10. The apparatus according to claim 1, wherein the base depth represents distribution in which closer to a lower end of the image, shallower depth is.

11. An image processing method of creating a depth map representing distribution of depths of pixels in an image, the method comprising:
detecting an area of a vertical object included in an image;
adding a base depth to the image, the base depth being a basic distribution of depths of pixels in the image;
acquiring at least one depth of a vicinity of a ground contact position of the vertical object from the base depth added to the image, and
creating the depth map by setting the acquired depth onto the base depth as a depth of the area of the vertical object.

12. A computer program product comprising a non-transitory computer-readable medium having programmed instructions to cause an image processing apparatus to create a depth map representing distribution of depths of pixels in an image, wherein the instructions, when executed by a computer, cause the computer to execute:
detecting an area of a vertical object included in an image;
adding a base depth to the image, the base depth being a basic distribution of depths of pixels in the image;
acquiring at least one depth of a vicinity of a ground contact position of the vertical object from the base depth added to the image; and
creating the depth map by setting the acquired depth onto the base depth as a depth of the area of the vertical object.
